(19) United States
(12) Patent Application Publication
(10) Pub. No.: US 2010/0191787 A1
(43) Pub. Date: Jul. 29, 2010

(54) Sequential Multiplier

(75) Inventor: Robert Chapman, Edmonton (CA)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/362,257

(22) Filed: Jan. 29, 2009

(51) Int. Cl. G06F 7/52; G06F 7/00

(52) U.S. Cl. 708/209; 708/627; 708/625

(57) ABSTRACT

A sequential multiplier for multiplying a binary multiplier and a binary multiplicand to produce a final product. A first logic circuit generates a control signal based on the multiplier. A second logic circuit generates a partial product based on the control signal and the multiplicand. A full adder generates a partial sum and a partial carry in each of a sequence of cycles. In the first cycle the partial sum and the partial carry are both initialized to zero. In each said cycle the partial sum, the partial carry, and the partial product are added to generate a new partial sum and a new partial carry. After a last cycle, the partial sum is the final product.

### COPYRIGHT NOTICE AND PERMISSION

This document contains some material which is subject to copyright protection. The copyright owner has no objection to the reproduction with proper attribution of authorship and ownership and without alteration by anyone of this material as it appears in the files or records of the Patent and Trademark Office, but otherwise reserves all rights whatsoever.

### BACKGROUND OF THE INVENTION

1. Technical Field

The present invention relates generally to electrical computers and digital processing systems having processing architectures and performing instruction processing, and more particularly to systems for multiplication that can be implemented in such.

2. Background Art

Binary multiplication can be performed by using serial bit multipliers or parallel bit multipliers.

The serial multiplier performs binary multiplication by loading a multiplicand and a multiplier into different registers and shifting the multiplier to the right one bit at a time. In each cycle, one multiplier bit is multiplied with the multiplicand to generate a partial product that is then shifted and added to the partial product generated in the next cycle. Each such addition can generate a carry bit at one or more of the bit positions, and these must all be propagated to the proper positions and added to the partial product of the succeeding cycle. The serial multiplier carries out bit multiplication by using a small amount of logic circuitry, but the amount of time taken to perform addition of the partial products and to propagate the carry bits is significant and this limits the speed of the serial multiplier.

In contrast, the parallel multiplier performs multiple add operations in an array of full adders that each generate a partial product. Each adder adds the partial product of the current stage to the partial product of the previous stage and provides the result to the next stage. The partial product sum generated by each full adder is propagated to the next stage rapidly through the array, with a final product being generated at the end (by the last full adder). The parallel multiplier overcomes the speed limitation of the serial multiplier, but instead has increased circuitry area and higher power consumption.

The use of conventional serial multipliers and parallel multipliers thus involve tradeoffs between speed, circuit area, and power consumption and it follows that there remains a need for a binary multiplier that is not so limited.

### BRIEF SUMMARY OF THE INVENTION

Accordingly, it is an object of the present invention to provide an improved binary multiplier.

Briefly, one preferred embodiment of the present invention is an apparatus for multiplying a binary multiplier and a binary multiplicand to produce a final product. A first logic circuit generates a control signal based on the multiplier. A second logic circuit generates a partial product based on the control signal and the multiplicand. A full adder generates a partial sum and a partial carry in each of a series of cycles. In the first cycle the partial sum and the partial carry are both initially zero, and in each cycle the partial sum, partial carry, and partial product are added to generate a new partial sum and a new partial carry. After the last cycle, the partial sum is the final product.

Briefly, another preferred embodiment of the present invention is a method for multiplying a binary multiplier and a binary multiplicand to produce a final product. The multiplier, the multiplicand, a partial sum with a value of zero, and a partial carry with a value of zero are provided. In each of a series of cycles a partial product is generated and the partial product, the partial sum, and the partial carry are added to generate new instances of the partial sum and the partial carry. After the last cycle, the partial sum is the final product.

Briefly, another preferred embodiment of the present invention is a method for multiplying a binary multiplier and a binary multiplicand to produce a final product. The multiplier, the multiplicand, a partial sum with a value of zero, and a partial carry with a value of zero are provided. Then if the least significant bit of the multiplier is zero, the partial sum is set to equal the multiplicand. Next, in a right shifting operation the multiplier is right shifting by one bit position. Then if the multiplier is zero and the partial carry is not zero, the partial sum and the partial carry are added to produce the final product and the method ends. Alternately, if the multiplier is zero and the partial carry is zero, the final product is set to equal the partial sum and the method ends. Conversely, if the multiplier is not zero and if the least significant bit of the multiplier is zero the partial sum and the partial carry are added to produce new values for the partial sum and the partial carry, and the method carries on from the right shifting operation. Alternately, if the multiplier is not zero and the least significant bit of the multiplier is not zero, the multiplicand is left shifting by one bit position, the multiplicand and the partial sum and the partial carry are added to produce new values for the partial sum and the partial carry, and the method carries on from right shifting operation.

Briefly, another preferred embodiment of the present invention is an apparatus for multiplying a binary multiplier and a binary multiplicand to produce a final product. The multiplier, the multiplicand, a partial sum with a value of zero, and a partial carry with a value of zero are provided. A means for right shifting the multiplier by one bit position, a means for left shifting the multiplicand by one bit position, a means for setting the partial sum to equal the multiplicand, a means for setting the final product to equal the partial sum, a means for adding the partial sum and the partial carry, a means for adding the multiplicand and the partial sum and the partial carry are all provided. A means to operate the means for setting the partial sum then operates if the least significant bit of the multiplier is zero. A means to operate the means for adding the partial sum and the partial carry (to produce a new value for the partial sum) and to also operate the means for setting the final product to equal the partial sum then operates if the multiplier is zero and the partial carry is zero. A means to operate the means for adding the partial sum and the partial carry (to produce new values for the partial sum and the partial carry) then operates if the multiplier is not zero and the least significant bit of the multiplier is zero. A means to operate the means for adding the multiplicand and the partial sum and the partial carry (to produce new values for the partial sum and the partial carry) then operates if the multiplier is zero and the least significant bit of the multiplier is zero.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures and tables of drawings in which:

FIG. 1 is a block diagram that illustrates the system level architecture of a sequential multiplier in accord with the present invention.

FIG. 2 is a block diagram that illustrates the multiplying block of FIG. 1 in more detail.

FIG. 3 is a flow chart depicting a binary multiplication method that may be used in the sequential multiplier.

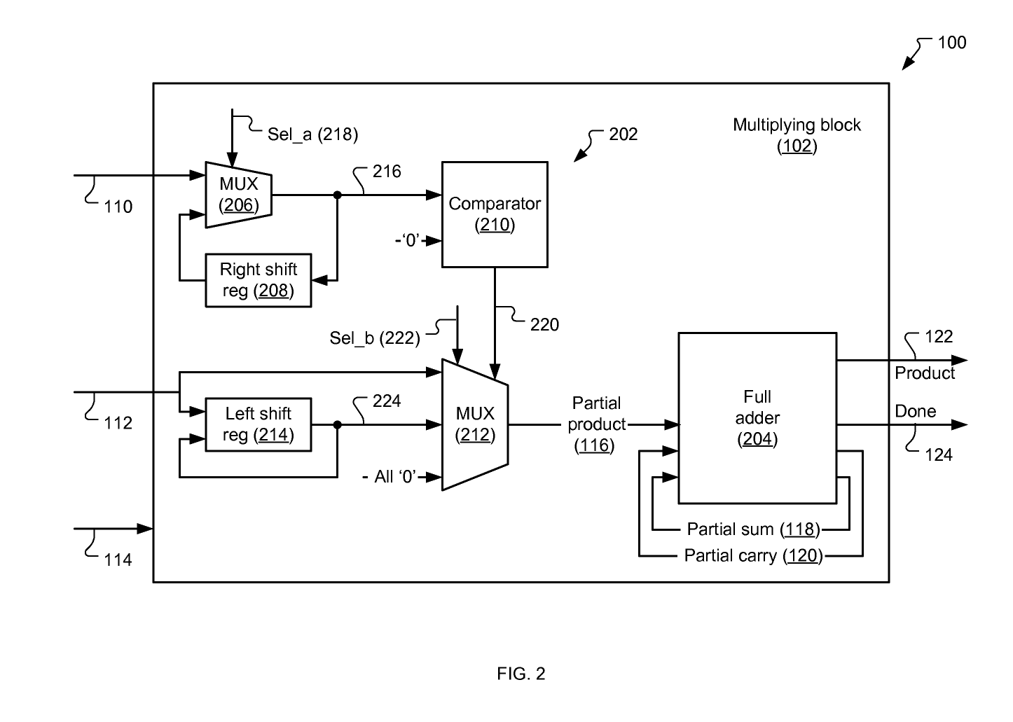

TABLE 1 shows how a select line and a control signal control three-way multiplexer depicted in FIG. 2.

TABLE 2 summarizes the various values in the cycles discussed with respect to FIG. 2.

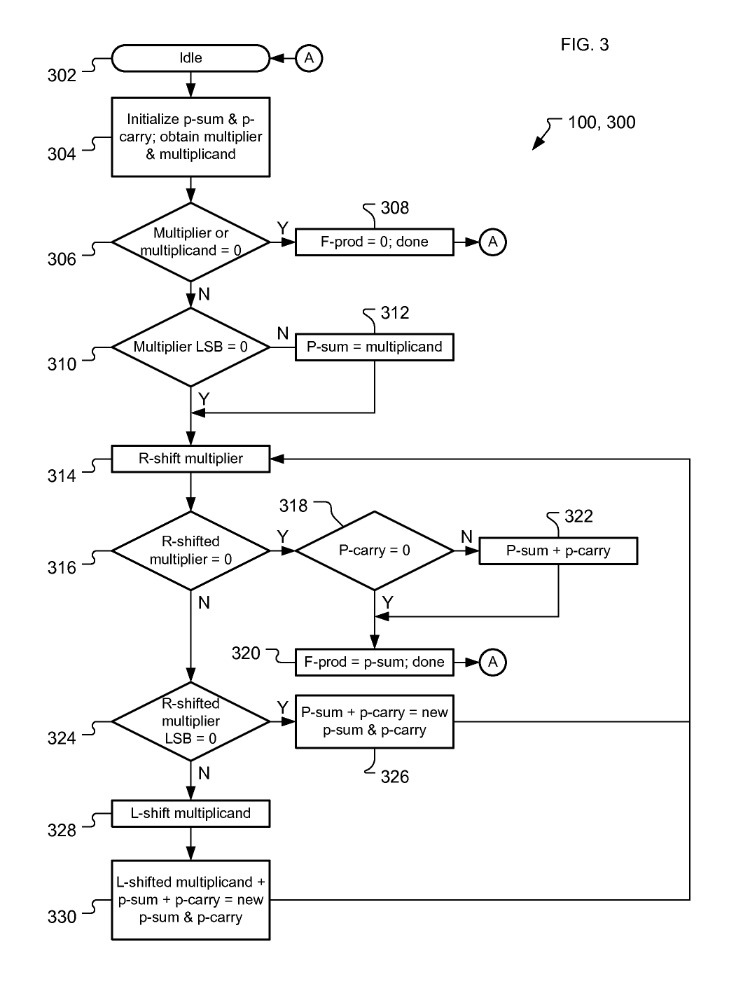

TABLE 3 summarizes the various values in the cycles discussed with respect to FIG. 3.

In the various figures of the drawings, like references are used to denote like or similar elements or steps.

### DETAILED DESCRIPTION OF THE INVENTION

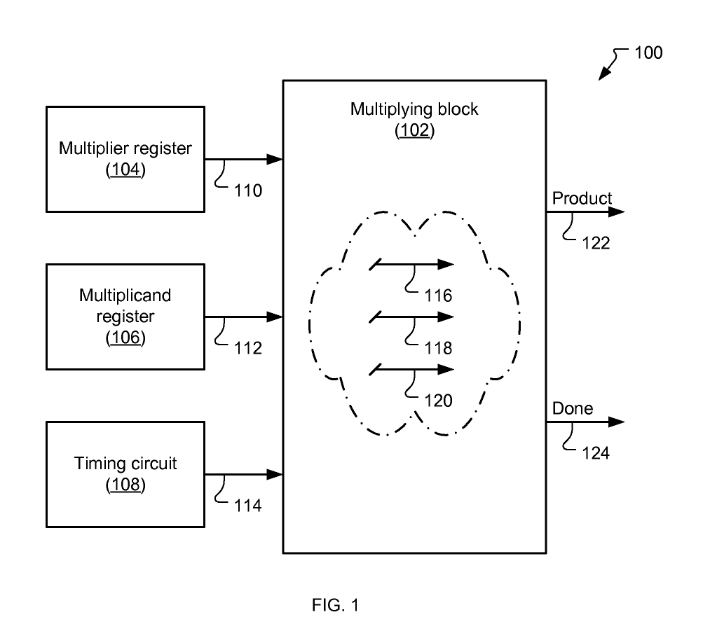

A preferred embodiment of the present invention is an improved binary multiplier, herein termed a “sequential multiplier.” As illustrated in the various drawings herein and particularly in the view of FIG. 1, embodiments of the invention are depicted by the general reference character 100.

FIG. 1 is a block diagram that illustrates the system level architecture of a sequential multiplier 100 in accord with the present invention. The sequential multiplier 100 includes a multiplying block 102 that is coupled to a multiplier register 104, a multiplicand register 106, and a timing circuit 108. The multiplying block 102 receives a multiplier 110 from the multiplier register 104 and a multiplicand 112 from the multiplicand register 106. The timing circuit 108 provides a clock 114 that triggers the operations in the multiplying block 102.

The multiplying block 102 performs binary multiplication by multiplying each bit of the multiplier 110 with the multiplicand 112. The number of bits in the multiplier 110 thus define the number of cycles in the binary multiplication. In every cycle the multiplying block 102 generates a partial sum 118, a partial carry 120, and a partial product 116 (all shown stylistically here in FIG. 1 and discussed in detail presently). In essence, the previous partial sum 118 and the previous partial carry 120 are added to the current partial product 116 in each cycle, and in the final cycle the multiplying block 102 generates a final product 122 and a done signal 124. If the multiplier 110 and the multiplicand 112 are n-bit binary values, then the partial product 116, the partial sum 118, the partial carry 120, and the final product 122 can be 2n-bit binary values.

FIG. 2 is a block diagram that illustrates the multiplying block 102 of FIG. 1 in more detail. As can be seen here, the multiplying block 102 includes logic circuits 202 and a full adder 204 to perform the binary multiplication. The logic circuits 202 include a two-way multiplexer 206, a right shift register 208, a one-bit comparator 210, a three-way multiplexer 212, and a left shift register 214.

The two-way multiplexer 206 receives two inputs to produce a two-way multiplexer output 216. One input here is the original multiplier 110 and the other input is a right shifted value based on this which is prepared by the right shift register 208. A first logic sub-circuit (not shown) sets a first select line 218 (sel_a) that determines which of the inputs becomes the two-way multiplexer output 216. The first select line 218 (sel_a) is set to a value of ‘0’ in the first cycle of the binary multiplication, and to a value of ‘1’ throughout the rest of the cycles. [Note, since the original multiplier 110 is only used in the first cycle, and right shifted values based on it are subsequently used, the value at the two-way multiplexer output 216 can simply be spoken of as the “multiplier” in some embodiments of the present invention, as discussed further presently.]

The one-bit comparator 210 compares the least significant bit (LSB) of what it receives in the two-way multiplexer output 216 with a value of ‘0’ to produce a control signal 220. If the LSB received is ‘0’, the one-bit comparator 210 sets the control signal 220 to ‘0’, and if the LSB is ‘1’ the one-bit comparator 210 sets the control signal 220 to ‘1’.

The three-way multiplexer 212 receives three inputs to produce an output that is the partial product 116. One input here is the original multiplicand 112, another input is a left shifted value based on this which is prepared by the left shift register 214 (a left shifted multiplicand 224), and the other input is an all zeros value. A second logic sub-circuit (not shown) sets a second select line 222 (sel_b) that, along with the control signal 220 determines which of the inputs becomes the output. The second select line 222 (sel_b) is set to a value of ‘0’ in the first cycle of the binary multiplication, and to a value of ‘1’ throughout the rest of the cycles. [Note, select line 218 (sel_a) and select line 222 (sel_b) can be the same in the embodiments of the present invention shown herein. Note also, since the original multiplicand 112 is only used in the first cycle and left shifted values based on it are subsequently used, the value of the partial product 116 can simply be spoken of as the “multiplicand” in some embodiments of the present invention, as discussed further presently.]

TABLE 1 shows how the second select line 222 (sel_b) and the control signal 220 control the three-way multiplexer 212. If the second select line 222 (sel_b) and the control signal 220 are both set to ‘0’, the three-way multiplexer 212 passes the all zeros value as the partial product 116. If the second select line 222 (sel_b) is set to ‘0’ and the control signal 220 is set to ‘1’, the three-way multiplexer 212 passes the original multiplicand 112 as the partial product 116. If the second select line 222 (sel_b) is set to ‘1’ and the control signal 220 is set to ‘0’, the three-way multiplexer 212 also passes the all zeros value as the partial product 116. If the second select line 222 (sel_b) is set to ‘1’ and the control signal 220 is set to ‘0’, the three-way multiplexer 212 passes the left shifted value based on the multiplicand as the partial product 116.

An example of binary multiplication of a 4-bit multiplicand of ‘1111’ and a 4-bit multiplier of ‘1111’ using the present invention is now discussed. Although a 4-bit multiplier is used here and as few as four cycles could be used, to facilitate understanding the first example below has five cycles, and a following example is presented with only four cycles.

Turning now to a hardware-based first example, we start with the multiplying block 102 in the first cycle. The first select line 218 (Sel_a) is set to ‘0’, and the two-way multiplexer 206 passes the value of the original multiplier 110 (‘1111’) as the two-way multiplexer output 216.

The one-bit comparator 210 then compares the least significant bit (LSB) of the two-way multiplexer output 216 to ‘0’, and since the LSB is ‘1’ here, the one-bit comparator 210 provides ‘1’ in the control signal 220.

Again, since this is the first cycle, the second select line 222 (Sel_b) is set to ‘0’. In response to this and the control signal 220 (‘1’), the three-way multiplexer 212 passes the value of the original multiplicand 112 as the partial product 116 (‘00001111’). Since this is the first cycle, the initialized partial sum 118 has the value ‘00000000’ and the initialized partial carry 120 has the value ‘00000000’. The full adder 204 then adds the partial product 116 (‘00001111’), the partial sum 118 (‘00000000’), and the partial carry 120 (‘00000000’) to produce a new partial sum 118 having the value ‘00001111’ and a new partial carry 120 having the value ‘00000000’. Concurrently, the right shift register 208 produces a value of ‘0111’ and the left shift register 214 produces a value of ‘0001111’.

After all of this, the multiplying block 102 determines if the bits in both the two-way multiplexer output 216 (now ‘0111’) and those in the partial carry 120 (now ‘00000000’) are all zeros. This is not the case yet, so the multiplying block 102 continues.

Now in the second cycle, the first select line 218 (Sel_a) is set to ‘1’ and the two-way multiplexer 206 passes ‘0111’ as the two-way multiplexer output 216. The one-bit comparator 210 compares the least significant bit (LSB) of this to ‘0’, and provides ‘1’ in the control signal 220.

Since this is a cycle other than the first, the second select line 222 (Sel_b) is set to ‘1’. In response to this and the control signal 220 (‘1’), the three-way multiplexer 212 passes ‘00011111’ in the partial product 116. The full adder 204 then adds the partial product 116 (‘00011110’), the partial sum 118 (‘00001111’), and the partial carry 120 (‘00000000’) to produce a new partial sum 118 having the value ‘00010001’ and a new partial carry 120 having the value ‘00011100’. Concurrently, the right shift register 208 produces a value of ‘0011’ and the left shift register 214 produces a value of ‘0011100’.

After all of this, the multiplying block 102 determines if the bits in both the two-way multiplexer output 216 (now ‘0011’) and the partial carry 120 (now ‘00011100’) are all zeros. This is not the case yet, so the multiplying block 102 continues.

Now in the third cycle, the first select line 218 (Sel_a) is set to ‘1’ and the two-way multiplexer 206 passes ‘0011’ as the two-way multiplexer output 216. The one-bit comparator 210 then compares the least significant bit (LSB) of this to ‘0’, and provides ‘1’ in the control signal 220.

Since this is a cycle other than the first, the second select line 222 (Sel_b) is set to ‘1’. In response to this and the control signal 220 (‘1’), the three-way multiplexer 212 passes the left shifted multiplicand 224 as the partial product 116 (‘00111100’). The full adder 204 then adds the partial product 116 (‘00111100’), the partial sum 118 (‘00010001’), and the partial carry 120 (‘00011100’) to produce a new partial sum 118 having the value ‘00110001’ and a new partial carry 120 having the value ‘0011000’. Concurrently, the right shift register 208 produces a value of ‘0001’ and the left shift register 214 produces a value of ‘01111000’.

After all of this, the multiplying block 102 determines if the bits in both the two-way multiplexer output 216 (now ‘0001’) and the partial carry 120 (now ‘00111000’) are all zeros. This is not the case yet, so the multiplying block 102 continues.

Now in the fourth cycle, the first select line 218 (Sel_a) is set to ‘1’ and the two-way multiplexer 206 passes ‘0001’ as the two-way multiplexer output 216. The one-bit comparator 210 then compares the least significant bit (LSB) of this to ‘0’, and provides ‘1’ in the control signal 220.

Since this is a cycle other than the first, the second select line 222 (Sel_b) is set to ‘1’. In response to this and the control signal 220 (‘1’), the three-way multiplexer 212 passes the left shifted multiplicand 224 as the partial product 116 (‘01111000’). The full adder 204 then adds the partial product 116 (‘01111000’), the partial sum 118 (‘00110001’), and the partial carry 120 (‘00111000’) to produce a new partial sum 118 having the value ‘01110001’ and a new partial carry 120 having the value ‘01110000’. Concurrently, the right shift register 208 produces a value of ‘0000’ and the left shift register 214 produces a value of ‘11110000’.

After all of this, the multiplying block 102 determines if the bits in both the two-way multiplexer output 216 (now ‘0000’) and the partial carry 120 (now ‘01110000’) are all zeros. This is not the case yet, so the multiplying block 102 continues.

Now in the fifth cycle, the first select line 218 (Sel_a) is set to ‘1’ and the two-way multiplexer 206 passes ‘0000’ as the two-way multiplexer output 216. The one-bit comparator 210 then compares the least significant bit (LSB) of this to ‘0’, and provides ‘0’ in the control signal 220.

Since this is a cycle other than the first, the second select line 222 (Sel_b) is set to ‘1’. In response to this and the control signal 220 (‘0’), the three-way multiplexer 212 passes the all zeros value as the partial product 116 (‘00000000’). The full adder 204 adds the partial product 116 (‘00000000’), the partial sum 118 (‘01110001’), and the partial carry 120 (‘00111000’) to produce a new partial sum 118 having the value ‘11100001’ and a new partial carry 120 having the value ‘00000000’. Concurrently, the right shift register 208 and the left shift register 214 produce values that are irrelevant.

These are irrelevant because, after all of this, the multiplying block 102 again determines if the bits in both the two-way multiplexer output 216 (now ‘0000’) and the partial carry 120 (now ‘00000000’) are all zeros. This is the case now, so the multiplying block 102 outputs the current partial sum 118 as the final product 122 (‘11100001’) and sets the done signal 124. TABLE 2 summarizes the various values in the five cycles discussed above.

FIG. 3 is a flow chart depicting a binary multiplication method 300 that may be used in the sequential multiplier 100. In a step 302, upon receiving power, a system employing the binary multiplication method 300 typically initially operates in an idle state for a pre-determined amount of time. In a step 304 the values of the partial sum 118 (p-sum) and the partial carry 120 (p-carry) are initialized to all zeros and the values of the multiplier 110 and the multiplicand 112 are received.

In a step 306 it is determined whether the values of either the multiplier 110 or the multiplicand 112 are zero. If so, the product of these must clearly also be zero, so in a step 308 the final product 122 (f-prod) is set to ‘0’, the done signal 124 is activated, and the binary multiplication method 300 returns to step 302.

Otherwise, in a step 310 it is determined whether the least significant bit (LSB) of the multiplier 110 is ‘0’. If not, in a step 312 the value of the partial sum 118 (p-sum) is set equal to that of the multiplicand 112, the partial carry 120 (p-carry) remains ‘00000000’, and the binary multiplication method 300 proceeds to step 314. Otherwise, the LSB of the multiplier 110 is ‘0’, and the values of the partial sum 118 (p-sum) and the partial carry 120 (p-carry) are left unchanged and the binary multiplication method 300 proceeds to step 314.

In step 314 the multiplier 110 is right shifted. Digressing briefly, it was noted in passing above that the original multiplier and the right shifted values based on it can collectively be termed the “multiplier” in some embodiments and that the original multiplicand and the left shifted values based on it can collectively be termed the multiplicand in such embodiments. Since the original values of the multiplier and the multiplicand are only needed during the first cycle, they can both be loaded into memory locations, for instance, respective registers that are altered in each cycle. The necessary shift operations in each cycle can be performed on these memory locations, simply overwriting prior the values in them.

Continuing, in a step 316 it is determined whether the value of the right-shifted multiplier is ‘0’. If so, in a step 318 it is further determined whether the value of the partial carry 120 (p-carry) is zero. If so, in a step 320 the value of the partial sum 118 (p-sum) is output as the final product 122 (f-prod), the done signal 124 is activated, and the binary multiplication method 300 returns to step 302. On the other hand, if the value of the partial carry 120 is not zero, in a step 322 the value of the partial sum 118 is added to the value of the partial carry 120 and the binary multiplication method 300 proceeds to step 320.

Continuing from step 316, if the value of the right-shifted multiplier is not ‘0’, in a step 324 it is further determined whether the least significant bit (LSB) of the right-shifted multiplier is ‘0’. If so, in a step 326 the partial sum 118 (p-sum) and the partial carry 120 (p-carry) are added together, generating new values for the partial sum 118 and the partial carry 120, and the binary multiplication method 300 returns to step 314 for the next cycle. Alternately, if in step 324 the LSB is ‘1’, then in a step 328 the multiplicand 112 is left shifted and in a step 330 the left-shifted multiplicand is added to the partial sum 118 and the partial carry 120, generating new values for the partial sum 118 and the partial carry 120, and the binary multiplication method 300 returns to step 314 for the next cycle. TABLE 3 summarizes the various values in the four cycles discussed above.

In summary, to perform the multiplication of two 4-bit binary numbers using a traditional full adder takes eight clock cycles, whereas performing such a multiplication with the proposed sequential multiplier requires only four clock cycles.

While various embodiments have been described above, it should be understood that they have been presented by way of example only, and that the breadth and scope of the invention should not be limited by any of the above described exemplary embodiments, but should instead be defined only in accordance with the following claims and their equivalents.

TABLE 1

| | | | | |
|---|---|---|---|---|
| Sel_b (222), | 00 | 01 | 10 | 11 |
| control (220): | | | | |
| Part prod (116): | All 0's | Multiplicand | All 0's | Left shifted |
| | | (112) | | value (224) |

TABLE 2

| | | | Partial | | Partial | R-shifted | L-shifted | Final |
|---|---|---|---|---|---|---|---|---|
| | Multiplier | Multiplicand | product | Partial sum | carry | multiplier | multiplicand | product |
| Cycle | (110) | (112) | (116) | (118) | (120) | (216) | (224) | (122) |
| | 1111 | 1111 | | 00000000 | 00000000 | | | |
| 1 | | | 00001111 | 00001111 | 00000000 | 0111 | 00011110 | |
| 2 | | | 00011110 | 00010001 | 00011100 | 0011 | 00111100 | |
| 3 | | | 00111100 | 00110001 | 00111000 | 0001 | 01111000 | |
| 4 | | | 01111000 | 01110001 | 01110000 | 0000 | 11110000 | |
| 5 | | | 00000000 | 11100001 | 00000000 | | | |
| | | | | | | | | 11100001 |

TABLE 3

| | | | R-shifted | L-shifted | | Partial | Final |
|---|---|---|---|---|---|---|---|
| | Multiplier | Multiplicand | multiplier | multiplicand | Partial sum | carry | product |
| Cycle | (110) | (112) | (216) | (224) | (118) | (120) | (122) |
| | 1111 | 1111 | | | 00000000 | 00000000 | |
| 1 | | | 0111 | 00011110 | 00010001 | 00011100 | |
| 2 | | | 0011 | 00111100 | 00110001 | 00111000 | |
| 3 | | | 0001 | 01111000 | 01110001 | 01110000 | |
| 4 | | | 0000 | 11110000 | 11100001 | 00000000 | |
| | | | | | | | 11100001 |

What is claimed is:

1. An apparatus for multiplying a binary multiplier and a binary multiplicand to produce a final product, comprising:
a first logic circuit to generate a control signal based on the multiplier;
a second logic circuit to generate a partial product based on said control signal and the multiplicand; and
a full adder to generate a partial sum and a partial carry in each of a plurality of cycles, wherein:
in a first said cycle said partial sum is zero and said partial carry is zero;
in each said cycle said partial sum, said partial carry, and said partial product are added to generate a new said partial sum and a new said partial carry; and
after a last said cycle said partial sum is the final product.

2. The apparatus of claim 1, wherein said first logic circuit generates said control signal based on a least significant bit of the multiplier.

3. The apparatus of claim 1, wherein said first logic circuit includes:
a first shift register, a first multiplexer, and a comparator;
said first shift register to right shift the multiplier by one bit at each said cycle to produce a right shifted multiplier;
said first multiplexer to selectively, based on a select signal, pass one of said multiplier and said right shifted multiplier as a first multiplexer output; and
said comparator to generate said control signal based on said first multiplexer output.

4. The apparatus of claim 1, wherein said second logic circuit includes:
a second shift register and a second multiplexer;
said second shift register to left shift the multiplicand by one bit during each said cycle to produce a left shifted multiplicand; and
said second multiplexer to selectively, based on a select signal and said control signal, pass one of said multiplicand, said left shifted multiplicand, and a zero value as said partial product.

5. A method for multiplying a binary multiplier and a binary multiplicand to produce a final product, comprising:
providing the multiplier, the multiplicand, a partial sum with a value of zero, and a partial carry with a value of zero; and
in each of a plurality of cycles:
generating a partial product; and
adding said partial product said partial sum and said partial carry to generate new instances of said partial sum and said partial carry, wherein after a last said cycle said partial sum is the final product.

6. The method of claim 5, wherein said generating of said partial product includes:
providing a control signal that is based on the multiplier; and
selecting a multiplexer input based on said control signal, wherein said multiplexer input is based on the multiplicand or is a zero value.

7. The method of claim 6, wherein said providing said control signal is based on a least significant bit of the multiplier.

8. The method of claim 6, wherein:
said providing said control signal includes right shifting the multiplier by one bit during each said cycle to produce a right shifted multiplier; and
said selecting said multiplexer input includes left shifting the multiplicand by one bit at each said cycle to produce a left shifted multiplicand.

9. A method for multiplying a binary multiplier and a binary multiplicand to produce a final product, comprising:
(a) providing the multiplier, the multiplicand, a partial sum with a value of zero, and a partial carry with a value of zero;
(b) determining whether a least significant bit of the multiplier is zero and, if so, setting said partial sum to equal the multiplicand;
(c) right shifting the multiplier by one bit position; and
(d) determining whether the multiplier is zero and:
(i) if the multiplier is zero, determining whether said partial carry is zero and:
(1) if said partial carry is not zero, adding said partial sum and said partial carry to produce the final product and ending the method; and
(2) if said partial carry is zero, setting the final product to equal said partial sum and ending the method;
(ii) if the multiplier is not zero, determining whether said least significant bit of the multiplier is zero and:
(1) if said least significant bit of the multiplier is zero, adding said partial sum and said partial carry to produce new values for said partial sum and said partial carry, and returning to said (c); and
(2) if said least significant bit of the multiplier is not zero, left shifting the multiplicand by one bit position, adding the multiplicand and said partial sum and said partial carry to produce new values for said partial sum and said partial carry, and returning to said (c).

10. The method of claim 9 further comprising, after said (a) and prior to said (b), determining whether either of the multiplier and the multiplicand is zero and, if so, setting the final product to zero and ending the method.

11. An apparatus for multiplying a binary multiplier and a binary multiplicand to produce a final product, comprising:
means for providing the multiplier, the multiplicand, a partial sum with a value of zero, and a partial carry with a value of zero;
means for right shifting the multiplier by one bit position;
means for left shifting the multiplicand by one bit position;
means for setting said partial sum to equal the multiplicand;
means for setting the final product to equal said partial sum;
means for adding said partial sum and said partial carry;
means for adding the multiplicand and said partial sum and said partial carry;
means to operate said means for setting said partial sum, if said least significant bit of the multiplier is zero;
means to operate said means for adding said partial sum and said partial carry to produce a new value for said partial sum and to then operate said means for setting the final product to equal said partial sum, if the multiplier is zero and said partial carry is zero;
means to operate said means for adding said partial sum and said partial carry to produce new values for said partial sum and said partial carry, if the multiplier is not zero and said least significant bit of the multiplier is zero; and
means to operate said means for adding the multiplicand and said partial sum and said partial carry to produce new values for said partial sum and said partial carry, if the multiplier is zero and said least significant bit of the multiplier is zero.

12. The apparatus of claim 11 further comprising means for setting the final product to zero, if either of the multiplier and the multiplicand is zero as provided by said means for providing.
